(19) United States
(12) Patent Application Publication
(10) Pub. No.: US 2020/0319677 A1
(43) Pub. Date: Oct. 8, 2020

(54) SCREEN PROTECTOR WITH ENGRAVED IMAGE

(71) Applicant: Clay Canning, Lakeland, FL (US)

(72) Inventor: Clay Canning, Lakeland, FL (US)

(21) Appl. No.: 16/543,417

(22) Filed: Aug. 16, 2019

Related U.S. Application Data
(60) Provisional application No. 62/750,199, filed on Oct. 24, 2018.

(51) Int. Cl. G06F 1/16; G06F 3/041

(52) U.S. Cl. CPC G06F 1/1637; G06F 3/041; H04B 1/3888; G06F 1/1626; G06F 2200/1634

(57) ABSTRACT

Described is a screen protector having a screen protector substrate and an image engraved or etched into a top surface of the screen protector substrate. When a screen onto which the screen protector is installed is not activated, the image is visible but when the screen is activated, the image is translucent, thereafter showing a screen image without showing the etched image.

### RELATED APPLICATIONS

This application claims the benefit of U.S. Application No. 62/750,199, entitled “Screen Protector With Engraved Image,” filed on Oct. 24, 2018, which is incorporated herein by reference in its entirety.

### FIELD

Some implementations relate generally to screen protectors, and more particularly, to screen protectors (e.g., tempered glass screen protectors) having an image engraved thereon.

### BACKGROUND

It may be desirable to provide a screen protector having an image engraved thereon that is visible or invisible based on certain predetermined criteria. Some implementations were conceived in light of the above-mentioned limitations, needs, or problems, among other things. The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations include a screen protector. The screen protector can include a screen protector substrate. The screen protector can also include an image that is one or more of engraved or etched into a top surface of the screen protector substrate, wherein when a screen onto which the screen protector is installed is not activated, the image is visible and when the screen is activated, the image is one of translucent or transparent.

Some implementations include a screen protector. The screen protector can include an image that is one of engraved or etched into a top surface of the screen protector, wherein when a screen onto which the screen protector is installed is not activated, the image is visible and when the screen is activated, the image is one of translucent or transparent.

In some implementations, the screen protector substrate can be made of one or more of glass, plastic, wood, fabric, metal, fiber, stone, natural, man-made, synthetic, artificial or composite material.

In some implementations, the screen protector can be made of one or more of glass, plastic, wood, fabric, metal, fiber, stone, natural, man-made, synthetic, artificial or composite material.

In some implementations, the image can include one or more of a graphical image or an alphanumeric image, wherein the alphanumeric image can include one or more of letters, numbers, or symbols. In some implementations, the one or more of engraving or etching can be performed using one or more of a mechanical technique, a laser technique, or a chemical technique.

In some implementations, the screen can be one of a mobile phone screen, a tablet computer screen, a laptop computer screen, a flat screen monitor screen, a flat screen television screen, a watch screen, a product display screen, a vehicle light screen, a vehicle windshield, a vehicle window screen, a vehicle interior display screen, a building display screen, a window screen, an appliance screen or a furniture screen. In some implementations, the screen can be one of a backlit display or a non-backlit display. In some implementations, the non-backlit display can be an OLED.

A method for protecting a screen can include installing a screen protector onto the screen, wherein the screen protector has an image that is one of etched or engraved into a top surface of the screen protector, and wherein when the screen onto which the screen protector is installed is not activated, the image is visible and when the screen is activated, the image is one of translucent or transparent.

In some implementations, the screen protector can be made of one or more of glass, plastic, wood, fabric, metal, fiber, stone, natural, man-made, synthetic, artificial or composite material. In some implementations, the image can include one or more of a graphical image or an alphanumeric image, wherein the alphanumeric image can include one or more of letters, numbers, or symbols. In some implementations, the one or more of engraving or etching can be performed using one or more of a mechanical technique, a laser technique, or a chemical technique.

In some implementations, the screen can be one of a mobile phone screen, a tablet computer screen, a laptop computer screen, a flat screen monitor screen, a flat screen television screen, a watch screen, a product display screen, a vehicle light screen, a vehicle windshield, a vehicle window screen, a vehicle interior display screen, a building display screen, a window screen, an appliance screen or a furniture screen. In some implementations, the screen can be one of a backlit display or a non-backlit display.

### BRIEF DESCRIPTION OF THE DRAWINGS

FIG. 1 is a diagram of an example screen protector with engraved image in accordance with some implementations.

FIG. 2 is a diagram of an example screen protector with engraved image being installed on a screen of a device in accordance with some implementations.

FIG. 3 is a diagram of an example screen protector with engraved image installed on a screen of a device in accordance with some implementations.

FIG. 4 is a diagram of an example screen protector with engraved image installed on a screen of a device having a backlight of the screen activated in accordance with some implementations.

FIG. 5 is a diagram of a side view of an example screen protector with engraved image being installed on a screen of a device in accordance with some implementations.

FIGS. 6A to 6C show a sequence of an example screen protector with engraved image being installed on a screen of a device in accordance with some implementations.

FIGS. 7A to 7C show a sequence of an example screen protector with engraved image being installed on a screen of a device having a backlight of the screen activated in accordance with some implementations.

### DETAILED DESCRIPTION

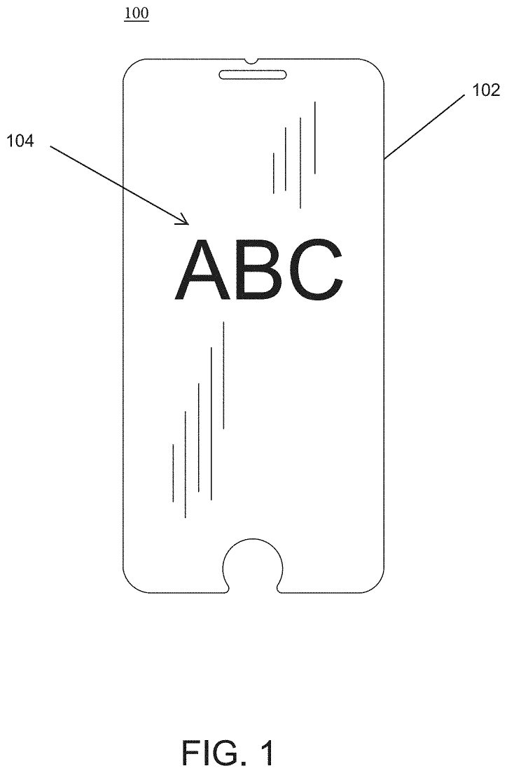

FIG. 1 is a diagram of an example screen protector 100 with engraved image in accordance with some implementations. The screen protector 100 includes a screen protector substrate 102 (e.g., tempered glass, plastic, or other suitable material). The screen protector substrate 102 has an image 104 engraved or etched into a top surface of the screen protector substrate 102. The top surface can be a surface of the screen protector substrate 102 that is facing away from a screen when the screen protector substrate 102 is installed on the screen or, in other words, the surface that is not in contact with the screen. The image 104 can include graphical images, letters, numbers, symbols, etc. In general, any graphical image and/or alphanumeric image can be included in image 104.

The image 104 can be engraved or etched into the screen protector substrate 102 using a mechanical technique, a laser etching technique, a chemical technique, and/or any other suitable technique. In some implementations, portions of the screen protector can be removed leaving only the portions that form the image.

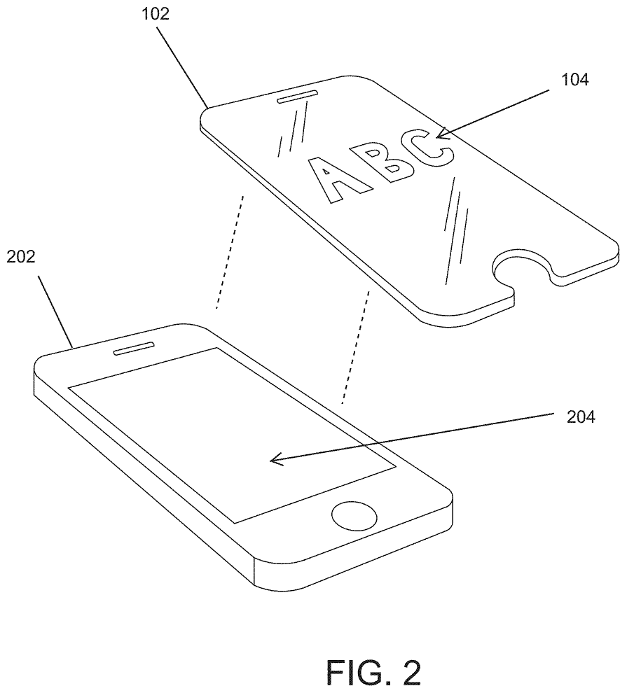

FIG. 2 is a diagram of an example screen protector with engraved image being installed on a screen of a device in accordance with some implementations. In particular, the screen protector substrate 102 with the image 104 engraved or etched thereon is shown in a process of being installed onto a screen 204 of a device 202. The screen protector substrate 102 with the engraved or etched image 104 can be installed on the screens of devices such as mobile phones, tablet computers, laptop computers, flat screen monitors, flat screen televisions, etc. A screen protector can also be made according to the present disclosure for a watch face (e.g., mechanical, electronic or computerized watches or wearable devices), display screens on buildings, windows, appliances, furniture, product displays, etc. An implementation can be made for a vehicle light (e.g., a headlight, a tail light, a fog light, etc.). An implementation can be made for a vehicle window, a vehicle windshield, or a vehicle interior display screen. In general, the screen protector substrate 102 with engraved or etched image 104 can be installed on any backlit display or non-backlit (e.g., OLED) display screen.

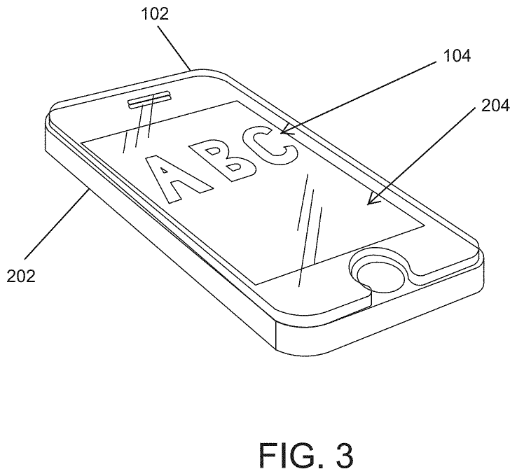

FIG. 3 is a diagram of an example screen protector substrate 102 with engraved image 104 installed on the screen 204 of the device 202 in accordance with some implementations.

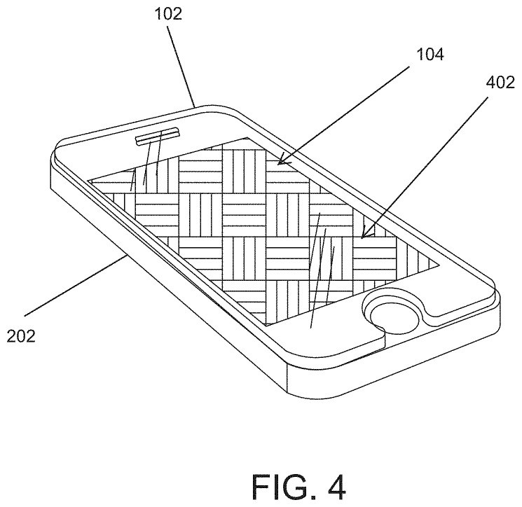

In FIG. 4, a light (e.g., backlight or internal light source) of a display screen has been activated and the image 104 is no longer visible because the image 104 becomes translucent and/or transparent when a light source of the display screen is activated and a screen image 402 becomes visible.

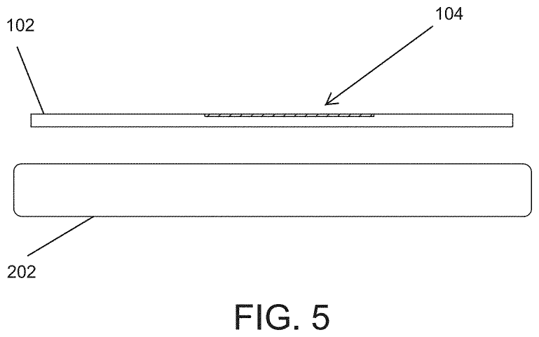

FIG. 5 is a diagram of a side view of an example screen protector with engraved image being installed on a screen of a device in accordance with some implementations. In particular, the screen protector substrate 102 with the image 104 is shown being installed on the device 202.

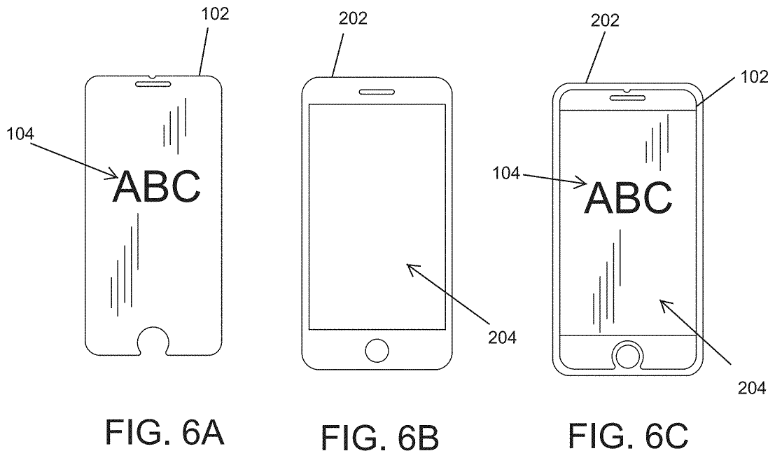

FIGS. 6A to 6C show a sequence of an example screen protector with engraved image being installed on a screen of a device in accordance with some implementations. FIG. 6A shows the screen protector substrate 102 with engraved or etched image 104 prepared to be installed on the screen 204 of the device 202 shown in FIG. 6B.

FIG. 6C shows the screen protector substrate 102 with engraved or etched image 104 installed on the screen 204 of the device 202 with a backlight (or other light source) of the display not activated such that the image 104 is visible.

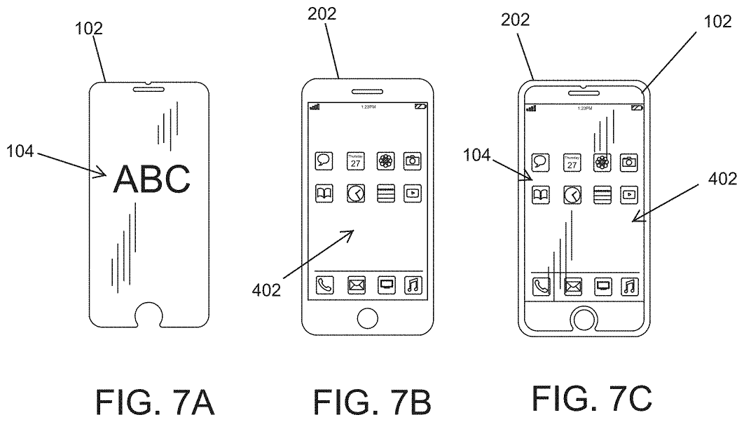

FIGS. 7A to 7C show a sequence of an example screen protector with engraved image being installed on a screen of a device in accordance with some implementations. FIG. 7A shows the screen protector substrate 102 with engraved or etched image 104 prepared to be installed on the screen 204 of the device 202, shown in FIG. 7B, which has its display activated with a backlight (or other light source) and shows a screen image 402.

FIG. 7C shows the screen protector substrate 102 with engraved or etched image 104 installed on the screen 204 of the device 202 with a backlight (or other light source) of the display activated such that the image 104 is not visible and the screen image 402 is visible.

It is, therefore, apparent that there is provided, in accordance with the various implementations disclosed herein, screen protectors (e.g., tempered glass screen protectors) having an image engraved thereon, wherein the image is visible when a backlight of a screen that the screen protector is installed on is not activated and the image becomes transparent and/or translucent when the backlight of the screen that the screen protector is installed on is activated.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A screen protector comprising:
a screen protector substrate; and
an image that is one or more of engraved or etched into a top surface of the screen protector substrate,
wherein when a screen onto which the screen protector is installed is not activated, the image is visible and when the screen is activated, the image is one of translucent or transparent.

2. The screen protector of claim 1, wherein the screen protector substrate is made of one or more of glass, plastic, wood, fabric, metal, fiber, stone, natural, man-made, synthetic, artificial or composite material.

3. The screen protector of claim 1, wherein the image includes one or more of a graphical image or an alphanumeric image, wherein the alphanumeric image includes one or more of letters, numbers, or symbols.

4. The screen protector of claim 1, wherein the one or more of engraving or etching is performed using one or more of a mechanical technique, a laser technique, or a chemical technique.

5. The screen protector of claim 1, wherein the screen is one of a backlit display or a non-backlit display.

6. The screen protector of claim 5, wherein the non-backlit display is an OLED.

7. The screen protector of claim 1, wherein the screen is one of a mobile phone screen, a tablet computer screen, a laptop computer screen, a flat screen monitor screen, a flat screen television screen, a watch screen, a product display screen, a vehicle light screen, a vehicle windshield, a vehicle window screen, a vehicle interior display screen, a building display screen, a window screen, an appliance screen or a furniture screen.

8. A screen protector comprising:
an image that is one of engraved or etched into a top surface of the screen protector, wherein when a screen onto which the screen protector is installed is not activated, the image is visible and when the screen is activated, the image is one of translucent or transparent.

9. The screen protector of claim 8, wherein the screen protector is made of one or more of glass, plastic, wood, fabric, metal, fiber, stone, natural, man-made, synthetic, artificial or composite material.

10. The screen protector of claim 8, wherein the image includes one or more of a graphical image or an alphanumeric image, wherein the alphanumeric image includes one or more of letters, numbers, or symbols.

11. The screen protector of claim 8, wherein the one or more of engraving or etching is performed using one or more of a mechanical technique, a laser technique, or a chemical technique.

12. The screen protector of claim 8, wherein the screen is one of a backlit display or a non-backlit display.

13. The screen protector of claim 12, wherein the non-backlit display is an OLED.

14. The screen protector of claim 8, wherein the screen is one of a mobile phone screen, a tablet computer screen, a laptop computer screen, a flat screen monitor screen, a flat screen television screen, a watch screen, a product display screen, a vehicle light screen, a vehicle windshield, a vehicle window screen, a vehicle interior display screen, a building display screen, a window screen, an appliance screen or a furniture screen.

15. A method for protecting a screen, the method comprising:
installing a screen protector onto the screen, wherein the screen protector has an image that is one of etched or engraved into a top surface of the screen protector, and wherein when the screen onto which the screen protector is installed is not activated, the image is visible and when the screen is activated, the image is one of translucent or transparent.

16. The method of claim 15, wherein the screen protector is made of one or more of glass, plastic, wood, fabric, metal, fiber, stone, natural, man-made, synthetic, artificial or composite material.

17. The method of claim 15, wherein the image includes one or more of a graphical image or an alphanumeric image, wherein the alphanumeric image includes one or more of letters, numbers, or symbols.

18. The method of claim 15, wherein the one or more of engraving or etching is performed using one or more of a mechanical technique, a laser technique, or a chemical technique.

19. The method of claim 15, wherein the screen is one of a backlit display or a non-backlit display.

20. The method of claim 15, wherein the screen is one of a mobile phone screen, a tablet computer screen, a laptop computer screen, a flat screen monitor screen, a flat screen television screen, a watch screen, a product display screen, a vehicle light screen, a vehicle windshield, a vehicle window screen, a vehicle interior display screen, a building display screen, a window screen, an appliance screen or a furniture screen.
